(19) United States
(12) Patent Application Publication
(10) Pub. No.: US 2009/0288915 A1
(43) Pub. Date: Nov. 26, 2009

(54) Method for Operating a Printing Press

(75) Inventors: Stefan ALBRECHT, Neusaess (DE); Nils-Hendric Schall, Augsburg (DE); Markus Weng, Alerheim (DE)

Correspondence Address: COHEN, PONTANI, LIEBERMAN & PAVANE LLP, 551 FIFTH AVENUE, SUITE 1210, NEW YORK, NY, 10176, US

(73) Assignee: manroland AG, Offenbach am Main (DE)

(21) Appl. No.: 12/468,970

(22) Filed: May 20, 2009

(30) Foreign Application Priority Data
May 21, 2008 (DE) 10 2008 024 616.6

(51) Int. Cl. F16N 29/00; G08B 21/00

(52) U.S. Cl. 184/36; 340/627

(57) ABSTRACT

A method of operating a printing press, wherein lubricated components of the printing press are lubricated with lubricant during the operation of the printing press in such a way that lubricant is taken from a reservoir via a feed line and is supplied to the component or components to be lubricated and in that the lubricant is carried away from the respective component to be lubricated in a post-feed area. Metal particles in the lubricant in the area downstream of the respective component to be lubricated are detected by means of a sensor. The state of the respective component to be lubricated is determined on the basis of this measurement and, if need be, a repair or exchange of the respective component to be lubricated is initiated.

### BACKGROUND OF THE INVENTION

1. Field of the Invention

The invention is directed to a method of operating a printing press wherein lubricated components of the printing press are lubricated with lubricant during the operation of the printing press in such a way that lubricant is taken from a reservoir via a feed line and is supplied to the component or components to be lubricated and in that the lubricant is carried away from the respective component to be lubricated in a post-feed area.

2. Description of the Related Art

Printing presses, e.g., roll-fed printing presses and sheet-fed printing presses, have a large number of components which must be lubricated with lubricant during the operation of the printing press. These components of a printing press which must be lubricated during operation are, e.g., gear units and bearings such as roller bearings, for example. During the operation of a printing press, the lubricated components of the printing press are subject to wear. If wear in the lubricated components is not detected in time, the components are prone to fail during the print run with the risk that other components of the printing press will be affected. This reduces the operating reliability of the printing press.

There has been no method until now for monitoring and detecting the state of lubricated components in a printing press. Consequently, lubricated components in printing presses are serviced or replaced after a fixed number of operating hours. In so doing, it may happen that components which are still in good working order are replaced. This reduces the economic efficiency of printing press operation.

### SUMMARY OF THE INVENTION

It is an object of the present invention to provide a method of operating a printing press which can increase operating reliability and profitability.

According to the present invention, metal particles in the lubricant in the area downstream of the respective component to be lubricated are detected by means of a sensor, and the state of the respective component to be lubricated is deduced on the basis of this measurement and, if need be, a repair or exchange of the respective component to be lubricated is initiated.

The present invention provides for the first time that metal particles in the lubricant in the area downstream of the lubricated component are detected by means of a sensor during operation of a printing press, and the state of the respective lubricated component is assessed on the basis of this measurement. In this way, the state of each lubricated component can be monitored individually and repair, servicing or exchange of the lubricated component can be initiated for every lubricated component individually. In this way, it is possible to make use of every lubricated component in the printing press to the fullest extent of its individual useful life and thus to increase efficiency while providing a highly reliable operation.

The various features of novelty which characterize the invention are pointed out with particularity in the claims annexed to and forming a part of the disclosure. For a better understanding of the invention, its operating advantages, and specific objects attained by its use, reference should be had to the drawing and descriptive matter in which there are illustrated and described preferred embodiments of the invention.

### BRIEF DESCRIPTION OF THE DRAWINGS

A preferred embodiment example of the present invention will be explained more fully with reference to the drawing in which:

FIG. 1 shows a block diagram illustrating the method according to the present invention.

### DETAILED DESCRIPTION OF THE PRESENTLY PREFERRED EMBODIMENTS

The present invention is directed to a method of operating a printing press in which the printing press comprises at least one lubricated component. The method according to the invention can be used in any printing presses, e.g., roll-fed printing presses or sheet-fed printing presses.

The lubricant that is used in particular is oil, and the lubricated component, or every lubricated component, of the printing press is accordingly constructed as an oil-lubricated component. The oil-lubricated components of the printing press are gear units and/or bearings.

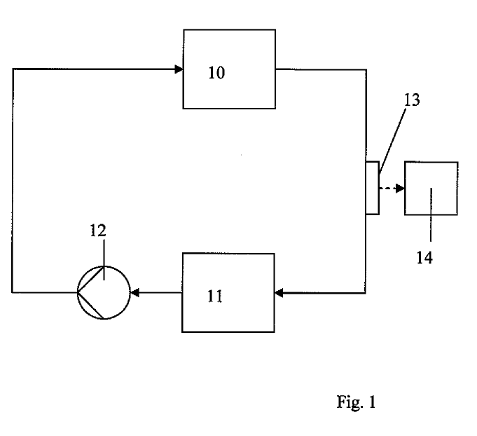

The invention will now be explained with reference to FIG. 1, in which an oil-lubricated component 10 of a printing press is shown by way of example. During operation, oil is supplied to the oil-lubricated component 10 via a feed line, the lubricant being removed from a reservoir 11 by means of a pump 12 and delivered in direction of the oil-lubricated component 10. The lubricant is carried away from the oil-lubricated component 10 in a post-feed area and returned to the reservoir 11 in the embodiment shown in FIG. 1 providing for a closed lubricating system.

A sensor 13 is positioned in the area downstream of the lubricated component 10, metal particles in the lubricant being detected by means of the sensor 13 in the area downstream of the oil-lubricated component 10. The sensor 13 sends its measurement results to an evaluating device 14 in which the state of the oil-lubricated component 10 is deduced based on the measurement signal of the sensor 13 and, if necessary, a repair or servicing or even an exchange of the lubricated component 10 is initiated. In this way, it is possible to initiate individual maintenance intervals for the oil-lubricated component 10 and to operate the latter for its maximum service life. Wear in the oil-lubricated component 10 can accordingly be detected in time to avoid failure of the same during the print run.

The sensor 13 is preferably an inductive sensor operating by the principle of inductive measurement.

The evaluating device 14 counts the metal particles in the post-feed lubricant based on the measurement signal generated by the sensor 13, and the state of the oil-lubricated component 10 is deduced on the basis of the quantity of metal particles in the lubricant which is determined in this way.

FIG. 1 shows the invention using the example of one oil-lubricated component 10. Typically, there is more than one oil-lubricated component which can be supplied with lubricant either from a common reservoir 11 or from individual reservoirs 11. Preferably, an individual sensor 13 is assigned to every oil-lubricated component in order to detect the metal particles present in the lubricant individually for every component in the post-feed area.

Accordingly, the present invention proposes a maintenance of the oil-lubricated components of a printing press which is oriented to their state. According to the present invention, the state of the oil-lubricated components is assessed by means of the metal particles abraded therefrom, the output of metal particles being counted, and therefore detected, by suitable sensors in the post-feed lubricant. The state of the oil-lubricated component is assessed based on the quantity of metal particles counted in this way and a repair, servicing or even replacement of the oil-lubricated component is initiated.

It is expressly noted that the (particle) sensor can be arranged in a bypass arrangement or secondary line with respect to the actual return flow. In that case, only a portion of the returning quantity of lubricant is monitored. Nevertheless, the state of the component to be lubricated can be deduced from the particle concentration determined by the sensor.

The invention is not limited by the embodiments described above which are presented as examples only but can be modified in various ways within the scope of protection defined by the appended patent claims.

We claim:

1. A method of operating a printing press, wherein components of the printing press are lubricated with lubricant during the operation of the printing press, said method comprising:
(a) taking lubricant from a reservoir via a feed line and supplying the lubricant to the component or components to be lubricated;
(b) carrying away the lubricant from the respective component to be lubricated in a post-feed area;
(c) detecting metal particles in the lubricant in the area downstream of the respective component to be lubricated by means of a sensor; and
(d) determining the state of the respective component to be lubricated on the basis of this measurement and, if need be;
(e) initiating a repair or exchange of the respective component.

2. The method according to claim 1, wherein the lubricant is oil.

3. The method according to claim 1, wherein the components to be lubricated are one of gear units and bearings.

4. The method according to claim 2, wherein the components to be lubricated are one of gear units and bearings.

5. The method according to claim 1, wherein step (c) is performed by using an induction sensor and by counting metal particles in the lubricant in the post-feed area based on the measurement signal of the sensor, and step (d) is performed by determining the state of the respective component to be lubricated from the quantity of metal particles in the lubricant.

6. The method according to claim 2, wherein step (c) is performed by using an induction sensor and by counting metal particles in the lubricant in the post-feed area based on the measurement signal of the sensor, and step (d) is performed by determining the state of the respective component to be lubricated from the quantity of metal particles in the lubricant.

7. The method according to claim 3, wherein step (c) is performed by using an induction sensor and by counting metal particles in the lubricant in the post-feed area based on the measurement signal of the sensor, and step (d) is performed by determining the state of the respective component to be lubricated from the quantity of metal particles in the lubricant.
